(19) United States
(12) Patent Application Publication
(10) Pub. No.: US 2001/0011009 A1
(43) Pub. Date: Aug. 2, 2001

(54) UNDERGROUND INFORMATION COMMUNICATION SYSTEM AND RELATED MANHOLE COVER

(76) Inventors: TOSHIO HARADA, YOKOHAMA-SHI (JP); YOJI SHIMIZU, MISATO-SHI (JP); YOSHIYUKI CHATANI, TOKYO (JP); TAKAYOSHI FURUNO, TOKYO (JP)

Correspondence Address: BURNS DOANE SWECKER & MATHIS L L P, POST OFFICE BOX 1404, ALEXANDRIA, VA, 22313-1404, US

(21) Appl. No.: 08/838,263

(22) Filed: Apr. 17, 1997

(30) Foreign Application Priority Data
Apr. 22, 1996 (JP) HEI 8-100545

(51) Int. Cl. H04B 13/02

(52) U.S. Cl. 455/40; 455/7; 455/39

(57) ABSTRACT

A manhole cover is provided with an incorporated radio repeater and a repeater antenna attached onto its rear surface. Another repeater antenna is provided inside the sewer below the manhole. This repeater antenna is connected to a radio transmitter/receiver, an electric-optical/optical-electric signal converter, and an optical fiber cable. With this arrangement, the manhole cover and optical fiber cable are connected via radio communication.

### BACKGROUND OF THE INVENTION

1. Field of the Invention

This invention relates to an information communication system using manhole covers as communication base stations.

2. Description of the Related Art

FIG. 6 illustrates a manhole antenna device and an information communication system disclosed in Japanese Patent Laid-Open No. Hei 5-227073. The drawing includes a manhole cover 1, a sewer 2, an antenna 3 incorporated into manhole cover 1, a radio transmitter/receiver 6, an electric-optical/optical-electric signal converter 7, an optical fiber cable 8, an optical fiber network 9, and a center station 20.

In operation, when signals are transmitted from center station 20, center station 20 outputs information signals into optical fiber network 9 via optical fiber cable 8. The signals are transmitted through optical-electric signal converter 7 and radio transmitter/receiver 6, and then they are irradiated towards the outside of a manhole in the form of radio electric waves via manhole cover antenna 3. Further, when radio electric waves arrive from outside of a manhole, they are received by manhole cover antenna 3 and radio transmitter/receiver 6, and converted into optical signals via electric-optical signal converter 7. The converted optical signals are transmitted via optical fiber cable 8 to optical fiber network 9 and center station 20. With this arrangement, an information communication system between a radio or mobile station 21 outside a manhole and a center station 20 is established.

However, conventional information communication systems such as the above system using a manhole cover as a communication base station experience problems when carrying out maintenance for the sewer because the manhole cover is directly connected to an optical fiber cable. It also suffers from limitations on places where a manhole communication base station (the above manhole cover) is installed because an optical fiber cable must be provided reaching the manhole.

### SUMMARY OF THE INVENTION

This invention has been conceived to overcome the above problems and aims to facilitate maintenance for a manhole cover and to reduce limitations on places where a manhole communication base station may be installed.

The present invention relates to an information communication system utilizing a sewer having a manhole cover provided at its entrance/exit.

The manhole cover incorporates an antenna (a manhole cover antenna) for communicating with the outside of the manhole and a repeater (a manhole cover repeater) connected thereto. This repeater is connected to a repeater antenna (a manhole cover side repeater antenna) for communicating by radio with the interior of a sewer. Since this repeater antenna is capable of radio communicating with a signal transmission path which is established inside the sewer, the manhole cover antenna does not need to be connected via a cable with the signal transmission path. Thus, accessibility and ease in removing such a manhole cover is improved.

The above signal transmission path includes an optical fiber cable. Optical communication enables high speed data communication. If an optical fiber cable is directly connected to a manhole cover, special care must be taken when moving the cover so as not to damage the optical fiber cable connected to the cover. In this invention, however, since an optical fiber cable is not directly connected to a manhole cover, operations including removing a cover can easily be performed.

In particular, a manhole cover side repeater antenna is preferably attached onto the rear surface of a manhole cover, the surface which faces the sewer. With this arrangement, no cables need be connected to the cover.

In another aspect, the manhole cover side repeater antenna is provided inside the sewer in the vicinity of the manhole cover, connecting via a co-axial cable to the radio repeater. This arrangement will eliminate the need for providing a signal transmission path, such as an optical fiber, reaching a manhole cover and thus reduces limitations on manhole installation locations. In other words, manholes can be installed where desired.

In another aspect, a transmission repeater device is provided inside a sewer, for repeating radio communication between a manhole cover side repeater antenna and a repeater antenna provided on a transmission path side (a transmission path side repeater antenna). With this arrangement, a communication path can easily be established partially by means of a radio communication, even in a sewer of a complicated shape. This arrangement is also effective in reducing limitations in the selection of an manhole locations.

A manhole cover side repeater comprises a band pass filter for selectively passing a signal in a predetermined frequency band and an amplifier for amplifying a signal. The repeater may have a simple structure.

The present invention also relates to a manhole cover to be installed at an entrance/exit of a sewer. The manhole cover includes a manhole cover antenna accommodated within the manhole cover for transmitting/receiving electric waves with respect to the outside of the sewer, a manhole cover radio repeater accommodated within the manhole cover and connected to the manhole cover antenna, and a manhole cover side antenna connected to the manhole cover radio repeater, for transmitting/receiving electric waves with respect to the inside of the sewer.

A manhole cover as described above is preferably for the information communication system of this invention.

### BRIEF DESCRIPTION OF THE DRAWINGS

The above and other objects, features, and advantages, will become further apparent from the following description of the preferred embodiment taken in conjunction with the accompanying drawings wherein:

FIG. 1 is a diagram illustrating an information communication system according to a first embodiment of the present invention;

FIG. 2 is a diagram illustrating an information communication system according to a second embodiment of the present invention;

FIG. 3 is a diagram showing a radio repeater according to a third embodiment of the present invention;

FIG. 4 is a diagram of an information communication system according to a fourth embodiment of the present invention;

FIG. 5 is a diagram illustrating a radio repeater of a fifth embodiment of the present invention; and

FIG. 6 is a diagram showing a conventional information communication system.

### PREFERRED EMBODIMENT OF THE INVENTION

### EMBODIMENT 1

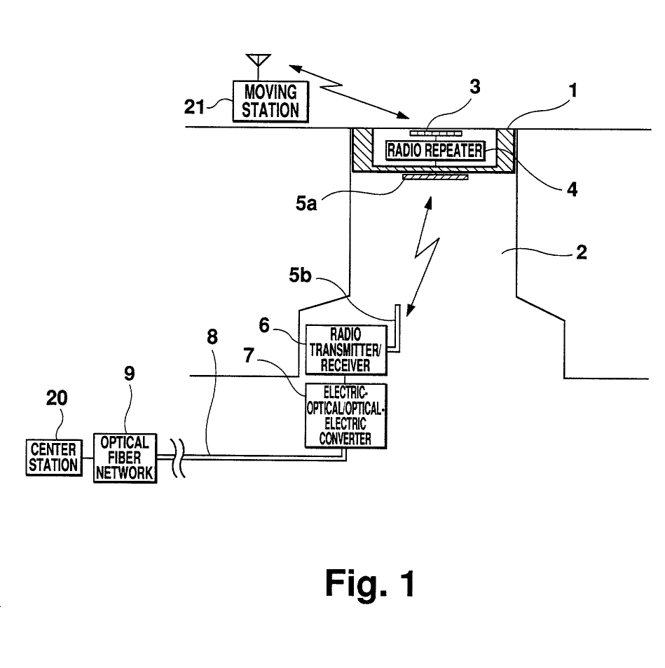

FIG. 1 shows an information communication system according to a first preferred embodiment of the present invention. This drawing includes a manhole cover 1, a sewer 2, a manhole cover antenna 3, a radio repeater 4, radio repeater antennas 5a, 5b, a radio transmitter/receiver 6, an electric-optical/optical-electric signal converter 7, an optical fiber cable 8, an optical fiber network 9, and a center station 20.

The operation will next be described using an example where signal transmission is directed from center station 20 towards the outside of manhole cover 1. Center station 20 supplies information signals into optical fiber network 9 via optical fiber cable 8. These signals are then transmitted as radio electric waves towards manhole cover 1 through optical-electric signal converter 7, radio transmitter/receiver 6, and radio repeater antenna 5b. These signals are received by radio repeater antenna 5a which is provided on the rear surface of manhole cover 1, and amplified by radio repeater 4. Amplified signals are transmitted towards the outside of the manhole cover 1 by manhole cover antenna 3.

In reverse transmission, manhole cover antenna 3 receives information signals arriving from the outside. Those signals are amplified by radio repeater 4 and the signals are transmitted in the direction of the bottom of the manhole of the sewer 2 as radio wave via radio repeater antenna 5a. The transmitted radio wave signals are received by radio repeater antenna 5b and radio transmitter/receiver 6 which are provided at a lower part of the manhole of the sewer 2, and converted into optical signals via electric-optical signal converter 7. The converted optical signals are transmitted via optical fiber cable 8 to optical fiber network 9 and further to center station 20. As described above, a communication path is established between center station 20 and a moving station 21 outside the manhole.

In the information communication system structured as above, manhole cover 1 is not directly connected to optical fiber cable 8. Such a structure is free from the risk of damaging optical fiber cable 8 when removing manhole cover 1 for carrying out maintenance for the manhole. In other words, this structure is advantageous in improving workability for manhole maintenance.

### EMBODIMENT 2

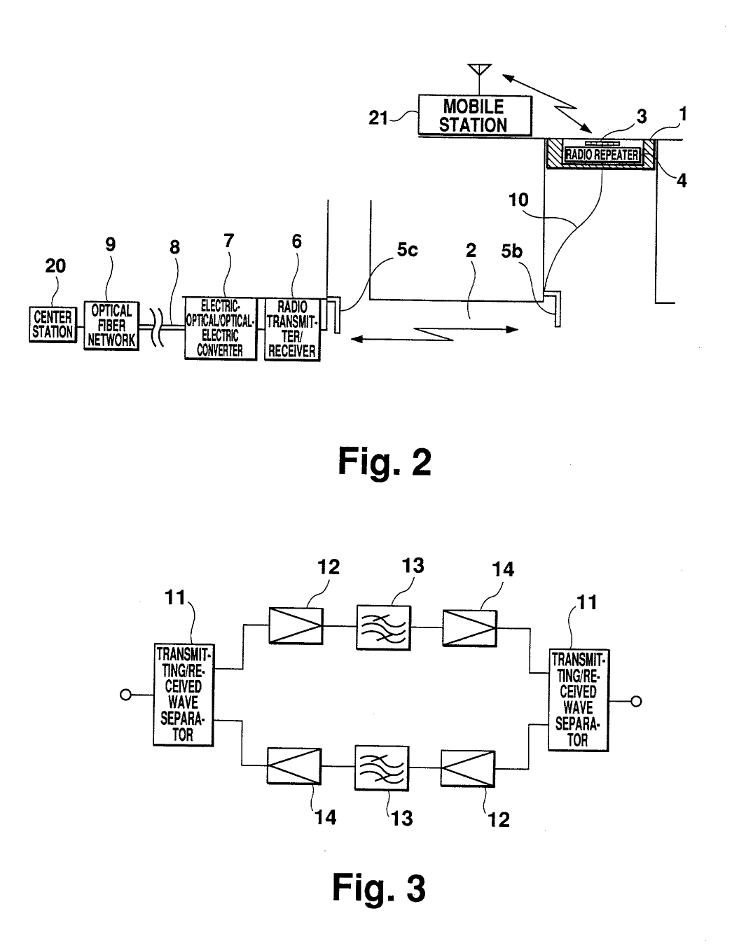

FIG. 2 shows an information communication system of a second embodiment of the present invention. This drawing includes a co-axial cable 10 in addition to the same elements with the same reference numerals as those in embodiment 1.

In this embodiment 2, a radio repeater antenna 5 is provided inside a sewer. As shown in FIG. 2, the radio repeater antenna is disposed at an intersection of a main sewer (horizontally extending) and the brand sewer (manhole). Radio electric waves transmitted from a radio repeater antenna 5b provided on the manhole cover 1 side is transmitted along the horizontally extending sewer to be received by a radio repeater antenna 5c provided on the optical fiber side which is located in a main sewer. In sewerage, with a diameter generally between 20 cm to 8 m, radio electric waves having a higher frequency than a cut-off frequency expressed in equation 1 are transmitted.

f_{c}=C/3.413a (equation 1)

wherein f_{c} is a cut-off frequency (Hz), c is an optical velocity (2.998×10¹¹ mm/s), and a is a diameter of a wave guide pipe (mm).

With this arrangement, manhole cover 1 can be radio connected to optical fiber cable 8 which is provided away from this manhole cover 1. In other words, it is unnecessary to provide an optical fiber cable 8 reaching manhole cover 1. As a result, limitations on the installation places of manhole cover 1 are reduced. Further, since it is generally considered that electric waves transmitting above the ground and within a sewer pipe are shielded from each other, radio connection established within a sewer pipe will not influence that above ground. Thus, the same frequency as that which is used above ground can be used within the sewer as well. This advantageously allows a wider selection of frequency.

### EMBODIMENT 3

FIG. 3 shows the structure of a radio repeater 4 of this invention. This drawing includes a transmitting/received wave separator 11, a low noise amplifier 12, a band pass filter (BPF) 13, and a high output amplifier 14. Separator 11 separates transmitting signals and received signals. Received signals are amplified by low noise amplifier 12 and filtered by BPF 13 so that only signals in a predetermined frequency band are passed through the filter. The signals obtained in a predetermined frequency band are amplified by high output amplifier 14, and then transmitted via separator 11.

A radio repeater 4 generally has a problem of an oscillation of the circuit because the antennas each connecting to each end of the radio repeater 4 are located close to each other are coupled to each other, so various countermeasures for avoiding the coupling of the antennas are thus employed. In this invention, a manhole cover antenna 3 is located sufficiently away from a radio repeater antenna 5, having a manhole cover 1 and a sewer intervening them. This structure allows even a radio repeater of such a simple structure as shown in FIG. 3 to present stable performance. Therefore, a low cost production of a device is realized.

### EMBODIMENT 4

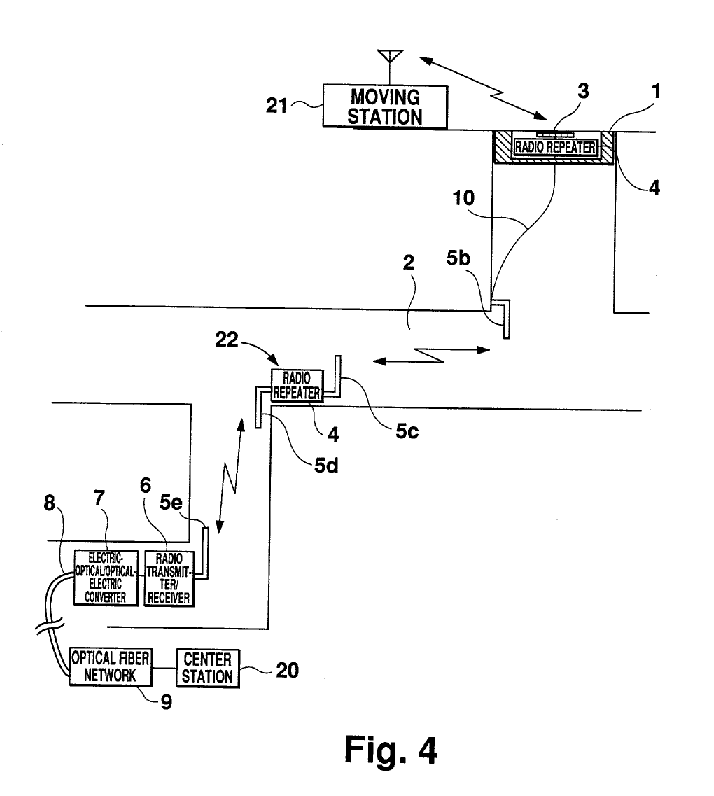

FIG. 4 shows an information communication system of a fourth embodiment of the present invention. In this drawing, respective reference numerals are the same as those used in the second embodiment.

In this embodiment, a transmission repeater device 22 which comprises at least one pair of radio repeater antennas 5c and 5d and a radio repeater 4 is provided between radio repeater antenna 5b below manhole cover 1 and a radio repeater antenna 5e on the optical fiber cable 8 side. Even in cases where radio transmission is employed in connecting between antennas in a sewer, a transmissible distance is still subject to limitations. That is, it is difficult to receive sufficient power in a long distance transmission. Even in a short distance, transmitting power is remarkably attenuated while passing through an angled or branching sewer. This invention, however, is free from the above problems since a communication repeater device 22 is disposed at branches and such midpoints of a transmission path. This structure is advantageous in further reducing the limitations on an installation place of a manhole cover.

### EMBODIMENT 5

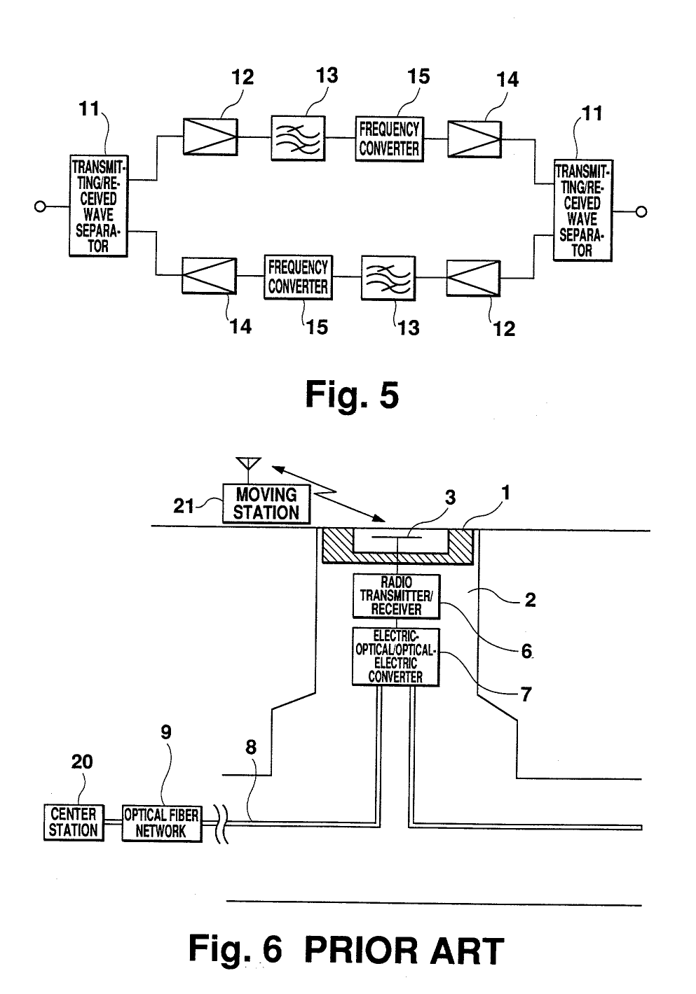

FIG. 5 shows the structure of a radio repeater 4 of this invention. This drawing includes a frequency converter 15 in addition to the same elements with the same reference numerals as those shown in FIG. 3.

In the information communication system of the fourth embodiment, radio repeater antennas 5c and 5d, each connected to each end of a transmission repeater device 22, cannot be located having a sufficient intervening distance as they are both provided within a sewer pipe. Then, their circuits are subject to oscillation due to a loop gain. In this embodiment, however, a loop gain can be reduced even if antenna are located having only an insufficient intervening distance, since a repeater 4 within transmission repeater device 22 incorporates a frequency converter 15 so that frequencies of electric waves at respective antenna 5c and 5d become different. As a result, a stable circuit which will not be oscillated is realized. Further, even if a plurality of manhole covers 1 are connected to one optical fiber cable 8, preferable communication quality can be obtained since frequencies of electric waves from respective manhole covers 1 can be changed.

While the above embodiments have been illustrated using a sewer system and manhole cover, it will be obvious that this information communication system may be used with many types of underground tunnel systems and covers and it is intended that all are included in the scope of this invention.

Further, it is to be understood that the words which have been chosen are intended to describe the invention and are not meant to limit the full scope and spirit of the invention as defined in the appended claims.

What is claimed is:

1. An underground information communication system having a manhole cover provided at its entrance/exit, comprising:
a signal transmission path provided inside the sewer;
a transmission path side repeater antenna provided inside the sewer connected to the signal transmission path;
a manhole cover side repeater antenna provided inside the sewer, for transmitting/receiving signals with respect to the transmission path side repeater antenna;
a manhole cover radio repeater provided with the manhole cover and connected to the manhole cover side repeater antenna; and
a manhole cover antenna provided with the manhole cover and connected to the manhole cover radio repeater, for transmitting/receiving signals with respect to outside of the sewer.

2. An information communication system as defined in claim 1, wherein
the signal transmission path includes an optical fiber cable which is connected to the transmission path side repeater antenna via a signal converter for performing signal conversion between an electric signal and an optical signal.

3. An information communication system as defined in claim 1, wherein
the manhole cover side repeater antenna is provided on a bottom surface of the manhole cover facing the sewer.

4. An information communication system as defined in claim 1, wherein
the manhole cover side repeater antenna is provided inside the sewer in a vicinity of the manhole cover and connected via a co-axial cable to the manhole cover radio repeater.

5. An information communication system as defined in claim 1, further comprising:
a transmission repeater device provided inside the sewer, for repeating radio communication between the transmission path side repeater antenna and the manhole cover side repeater antenna.

6. An information communication system as defined in claim 5, wherein
the transmission repeater device includes a first antenna for communicating with the transmission path side repeater antenna, a second antenna for communicating with the manhole cover side repeater antenna, and a radio repeater for connecting the first and second antenna.

7. An information communication system as defined in claim 1, wherein
the manhole cover radio repeater includes a band pass filter for selectively passing a signal in a predetermined frequency band, and an amplifier for amplifying a signal.

8. An information communication system as defined in claim 1, wherein
the sewer is provided with a plurality of manhole covers, and
each of the plurality of manhole covers is provided with the manhole cover antenna, the manhole cover radio repeater, and the manhole cover side repeater antenna.

9. An information communication system as defined in claim 8, wherein
the signal transmission path is connected to an information center.

10. A manhole cover provided to an entrance/exit of a sewer, comprising:
a manhole cover antenna accommodated with the manhole cover, for transmitting/receiving electric waves with respect to outside of the sewer;
a manhole cover radio repeater accommodated with the manhole cover and connected to the manhole cover antenna; and
a manhole cover side antenna connected to the manhole cover radio repeater, for transmitting/receiving electric waves with respect to inside of the sewer.

11. A manhole cover as defined in claim 10, wherein
the manhole cover side antenna is provided on a bottom surface of the manhole cover.

12. A manhole cover as defined in claim 10, wherein
the manhole cover side antenna is provided separately from the manhole cover, and connected via a co-axial cable to the manhole cover radio repeater provided within the manhole cover.

13. An information communication system as defined in claim 10, wherein
the manhole cover radio repeater includes a band pass filter for selectively passing a signal in a predetermined frequency band, and an amplifier for amplifying a signal.
